(19) United States
(12) Patent Application Publication
(10) Pub. No.: US 2023/0194336 A1
(43) Pub. Date: Jun. 22, 2023

(54) DEVICE FOR DETECTING AND ANALYTE IN SAMPLE

(71) Applicant: SUGENTECH, INC., Daejeon (KR)

(72) Inventors: Minwoo KIM, Daejeon (KR); Mihee NOG, Daejeon (KR); Rimi LEE, Daejeon (KR); Eunkyung KIM, Daejeon (KR); Seungbum YOO, Yongin-si (KR); Mi-Jin SOHN, Daejeon (KR)

(73) Assignee: SUGENTECH, INC., Daejeon (KR)

(21) Appl. No.: 17/922,578

(22) PCT Filed: Apr. 29, 2021
(86) PCT No.: PCT/KR2021/005479

§ 371 Date: Oct. 31, 2022

(30) Foreign Application Priority Data
May 29, 2020 (KR) 10-2020-0065223

(51) Int. Cl. G01J 1/02; G01N 21/01; G01N 21/88

(52) U.S. Cl. CPC G01J 1/0223; G01J 1/0228; G01N 21/01; G01N 21/88

(57) ABSTRACT

The present invention relates to a device for detecting an analyte in a sample, of which the sensitivity is improved by changing the structure. The device for detecting analyte in a sample of the present invention has the effect of improving measurement sensitivity and accuracy by arranging a light source and a photosensor to correspond to an inspection area and a control area, forming holes at positions corresponding to respective light source units, the photosensor, the inspection area, and a calibration area, and adding a stick housing having stick housing partitions formed around the holes.

### TECHNICAL FIELD

The present invention relates to a device for detecting an analyte in a sample, and more particularly, to a device for detecting an analyte in a sample having improved sensitivity by changing a structure.

### BACKGROUND ART

Among the analysis methods of biological materials based on optical methods, analysis methods using immunochromatography, biochemical reaction (color change), fluorescence reaction, and time-division fluorescence reaction use markers such as radioactive materials, enzymes, fluorescent materials, chemiluminescent materials, gold nanoparticles, carbon black, latex particles, quantum dots, etc., and in the case of detection of an optical phenomenon indicated by the markers, a reaction may be determined by the naked eyes according to the method, and a device that analyzes it to obtain more quantitative results was used. In an optical measurement of a biological material, the intensity of signals appears to be different depending on a concentration of a biological material. Most of these signals are measured by setting a reference for noise, and here, a signal-to-noise ratio should be efficiently measured to increase the accuracy. In order to measure the signal-to-noise ratio, it is common to use methods such as initial calibration or background calibration before a reaction alone or in combination.

In the related art regarding the method of analyzing a biological material based on such an optical method, a physical separation unit is not installed between measurement areas on the device for detecting an analyte in a sample, and a light transmission path from a light source – inspection area (calibration area) – photosensor is formed as a multi-channel so that the structural number of the light sources and the photosensors are shared with each other.

However, this concept of sharing the light source unit or the photosensor cannot optimize a distance of the light source – device – the photosensor, and loss and interference occur between light sources and photosensors adjacent to each other until a light source reaches the device for detecting an analyte in a sample and reflected light reaches the photosensor. As a result, light scattering and noise occur, which have a disadvantage in that the sensitivity and accuracy of the sensor are deteriorated.

### DISCLOSURE

### Technical Problem

An object of the present invention is to provide a device for detecting an analyte in a sample, in which a light source and a photosensor are arranged to correspond to an inspection area and a calibration area, a hole is formed in a position corresponding to each of the light source part, the photosensor, and the inspection and calibration areas, and a stick housing having a partition is added around the hole, thereby improving measurement sensitivity and accuracy.

Another object of the present invention is to provide a device for detecting an analyte in a sample, in which an optical mechanism part including a hole and a partition are arranged between a stick housing and a substrate and the hole formed in the optical mechanism part is formed to be larger to block light scattering, thereby further improving measurement sensitivity and accuracy.

Still another object of the present invention is to provide a device for detecting an analyte in a sample, in which an optical mechanism part is darkened in color or surface-treated to absorb light to block light scattering, thereby further improving measurement sensitivity and accuracy.

### Technical Solution

In one general aspect, a device for detecting an analyte in a sample includes: a substrate including n measurement units; and a stick housing accommodating a measurement target including n measurement areas spaced apart from each other, and stacked on the substrate, wherein the stick housing includes n stick housing through-holes formed on an upper side corresponding to the n measurement units in a direction facing the substrate and a stick housing partition formed between the respective stick housing through-holes, wherein the stick housing through-holes are formed at a position corresponding to the measurement units, and n is a natural number greater than 2.

In addition, each of the measurement units may include at least one light source irradiating light to the measurement target and at least one photosensor receiving and sensing light reflected from the measurement target, and the measurement units are spaced apart from each other.

In addition, the device may include: an optical mechanism part stacked on the substrate and the stick housing, wherein the optical mechanism part includes a through-hole for light source on an upper side corresponding to the light source and a through-hole for a photosensor on an upper side corresponding to the photosensor.

In addition, the device may further include: a controller connected to the measurement unit, wherein when the measurement units are respectively first to n-th measurement units arranged in order in one direction, the light source included in the n-th measurement unit is an n-th light source, and the photosensor included in the n-th measurement unit is an n-th photosensor, the controller sequentially operates the first to n-th light sources one by one, receives only an output from a j-th photosensor corresponding to a j-th light source, among the first to n-th optical sensors, operated at an operating time of each light source, and 1≤j≤n.

In addition, the device may further include: a controller connected to the measurement unit, wherein when the measurement units are respectively first to n-th measurement units arranged in order in one direction, the light source included in the n-th measurement unit is an n-th light source, and the photosensor included in the n-th measurement unit is an n-th photosensor, the controller divides the first to n-th measurement units into a plurality of groups, simultaneously operates light sources included in a plurality of measurement units belonging to one group, and receives result values from photosensors corresponding to the simultaneously operated light sources, and each group operates at a different time.

In addition, each of the measurement units included in one group of the measurement units may be located in positions that are not adjacent to each other.

In addition, the device may further include: a controller connected to the measurement unit, wherein when the measurement units are respectively first to n-th measurement units arranged in order in one direction, the light source included in the n-th measurement unit is an n-th light source, and the photosensor included in the n-th measurement unit is an n-th photosensor, the controller turns on a (j-1)-th light source and a (j+1)-th light source, measures a value of the j-th photosensor to calculate a noise value, and 1≤j≤n in which j is a natural number.

### Advantageous Effects

In a device for detecting an analyte in a sample of the present invention according to the above configuration, a light source and a photosensor are arranged to correspond to an inspection area and a calibration area, holes are formed at positions corresponding to the light source unit, the photosensor, and the inspection and calibration areas, and a stick housing in which partitions are formed is added around the hole, thereby improving measurement sensitivity and accuracy.

In addition, by arranging the optical mechanism part having the hole and the partitions between the stick housing and the substrate and forming the hole formed in the optical mechanism part to have a larger size, there is an effect of blocking light scattering and further improving the measurement sensitivity and accuracy.

In addition, by performing surface-treatment to darken a color of the optical mechanism part or absorb light, light scattering may be blocked, thereby further improving the measurement sensitivity and accuracy.

### BRIEF DESCRIPTION OF THE DRAWINGS

FIG. 1 is an exploded perspective view of a device for detecting an analyte in a sample according to the present invention.

FIG. 2 is a top view showing a coupling relationship between a stick housing and a measurement unit of the present invention.

FIG. 3 is a partially enlarged view of a substrate of the present invention.

FIG. 4 is an exploded perspective view of a device for detecting an analyte in a sample including an optical mechanism part of the present invention.

FIG. 5 is a top view showing a coupling relationship between an optical mechanism part and a measurement unit of the present invention.

FIG. 6 is a top view of a stick housing of the present invention.

FIG. 7 is a conceptual diagram showing an operation of the measurement unit of the present invention.

FIG. 8 is a conceptual diagram illustrating an operation of a device for detecting an analyte in a sample including a controller of the present invention.

FIG. 9 is a conceptual diagram illustrating a first exemplary embodiment of a control method of the present invention.

FIG. 10 is a conceptual diagram illustrating a second exemplary embodiment of a control method of the present invention.

### BEST MODE

Hereinafter, the technical idea of the present invention will be described in more detail with reference to the accompanying drawings. Prior to the description of the present invention, terms and words used in the present specification and claims to be described below should not be construed as limited to ordinary or dictionary terms, and should be construed in accordance with the technical idea of the present invention based on the principle that the inventors can properly define their own inventions in terms of terms in order to best explain the invention.

Therefore, the embodiments described in the present specification and the configurations illustrated in the drawings are merely the most preferred embodiments of the present invention and are not intended to represent all of the technical ideas of the present invention, and thus should be understood that various equivalents and modifications may be substituted at the time of the present application.

Hereinafter, the technical idea of the present invention will be described in more detail with reference to the accompanying drawings. Since the accompanying drawings are merely examples shown to explain the technical idea of the present invention in more detail, the technical idea of the present invention is not limited to the form of the accompanying drawings.

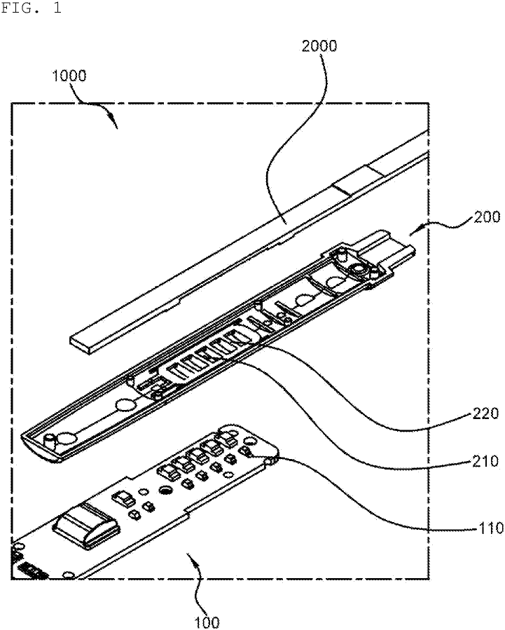

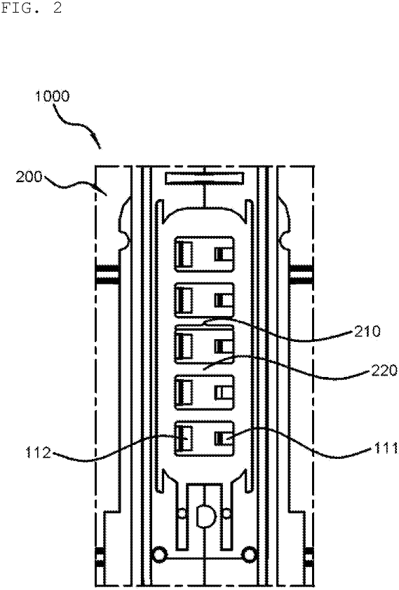

Hereinafter, a basic configuration of a device 1000 for detecting an analyte in a sample according to the present invention will be described with reference to FIGS. 1 and 2.

The device 1000 for detecting an analyte in a sample according to the present invention may include a substrate 100 and a stick housing 200 stacked on an upper side of the substrate 100. The upper side indicates a z-axis direction of a coordinate axis shown in FIG. 1. The substrate 100 may be a PCB substrate 100. The substrate 100 may include a measurement unit 110, and the measurement unit 110 may irradiate light to a measurement target 2000 to perform immunochromatography and analyze the irradiated light. n measurement units 110 may be disposed on the substrate 100. In this case, n is a natural number equal to or greater than 2, and each measurement unit 110 may measure both an inspection area and a control area, or may measure only the inspection area.

The stick housing 200 may accommodate the measurement target 2000. The measurement target 2000 may be inserted into and separated from the device 1000 for detecting an analyte in a sample by a user. The measurement target 2000 may include n measurement areas, and each measurement area may be an inspection area (color development line), a control area (background area), etc. and may include different materials. As described above, it is preferable that the same number of the measurement areas and the measurement units 110 exist, and it is preferable that one measurement unit 110 operates to correspond to one measurement area.

In addition, the stick housing 200 may be made of white or other colors for the convenience of the user.

The stick housing 200 may have a stick housing through-hole 210 in a direction facing the substrate 100. Also, n stick housing through-holes 210 may be formed so that the measurement unit 110 and the measurement area may correspond to each other in a one-to-one manner. The stick housing through-hole 210 is preferably formed at an upper side corresponding to the measurement unit 110 so that the measurement unit 110 and the measurement area corresponding to the measurement unit 110 communicate with each other. In addition, it is preferable that the stick housing through-hole 210 is formed to include all areas in which each component of the measurement unit 110 is formed. The relationship between the stick housing through-hole 210 and the measurement unit 110 is illustrated in FIG. 2, which shows a shape in which the stick housing 200 and the substrate 100 are coupled.

That is, with the above characteristics, light generated from the measurement unit 110 of the substrate 100 may be irradiated to a measurement area of the measurement target 200 through the stick housing through-hole 210.

A stick housing partition 220 may be formed between the stick housing through-holes 210, and the stick housing partition 220 may serve to separate each measurement unit 110 and a measurement area. By forming the stick housing partition 220, external light or light generated from the measurement unit 110 corresponding to another measurement area may be prevented from being irradiated to the measurement area, and only light generated from the measurement unit 110 may be measured, so that analysis of a biological material based on an optical method may be performed only between the corresponding measurement area and the measurement unit 110.

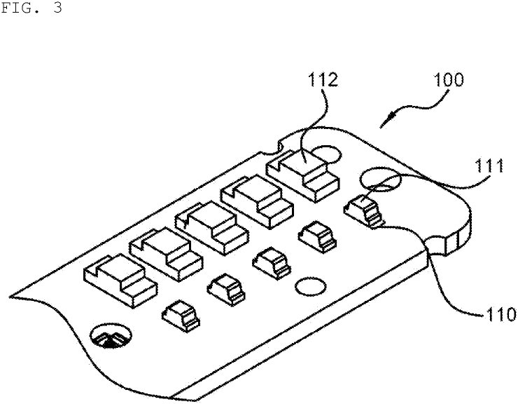

Hereinafter, the measurement unit 110 will be described with reference to FIG. 3.

Each of the measurement units 110 includes at least one light source 111 irradiating light to the measurement target 2000 and at least one photosensor 112 receiving and detecting light reflected from the measurement target 2000. More preferably, one measurement unit 110 may preferably include one light source 111 and one photosensor 112. In addition, it is preferable that the measurement units 110 are spaced apart from each other by a predetermined interval as shown in FIG. 3. As the measurement units 110 are spaced apart from each other, space for a stick housing partition 220 of the stick housing 200 or an optical mechanism part partition 330 formed due to an optical mechanism part 300 to be described below to be located may be secured on an upper side of a position corresponding to between each measurement area, so that the stick housing partition 220 or the optical mechanism part partition 330 do not interfere with each other in the role of the light source 111 and the photosensor 112 irradiating and receiving light to and from the measurement target 2000.

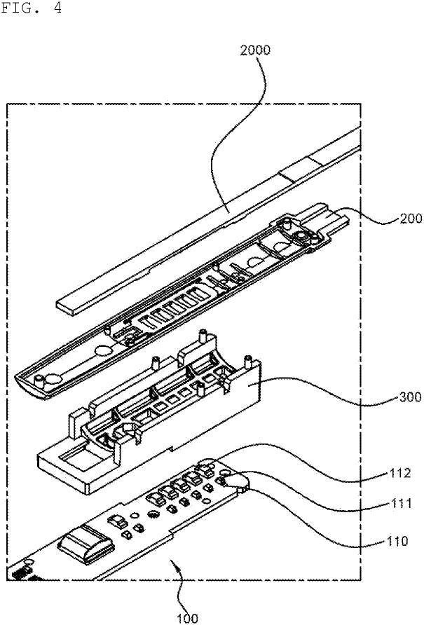

Hereinafter, the optical mechanism part 300 will be described with reference to FIGS. 4 to 7.

The device 1000 for detecting an analyte in a sample according to the present invention may further include the optical mechanism part 300 stacked on the substrate 100 and the stick housing 200 as shown in FIG. 4. The optical mechanism part 300 is preferably disposed between the substrate 100 and the stick housing 200. In addition, the optical mechanism part 300 may be formed in a structure surrounding the substrate 100 and the stick housing 200. The optical mechanism part 300 may have a color capable of absorbing light or may be coated with a color capable of absorbing light, and may be subjected to a surface treatment to absorb light. As the optical mechanism part 300 is further provided, the straightness of the light source 111 may be improved.

An upper surface of the optical mechanism part 300, that is, a surface of the optical mechanism part 300 coupled to the stick housing 200, may be formed in a shape corresponding to a lower surface of the stick housing 200. The shape shown in FIG. 4 is an example, and when the lower surface of the stick housing 200 is formed as a convexly curved surface, the upper surface of the optical mechanism part 300 may be formed in a concavely curved surface so that the optical mechanism part 300 may be easily coupled to the stick housing 200. That is, it is preferable that the optical mechanism part 300 is formed to be easily applied and coupled to the stick housing 200.

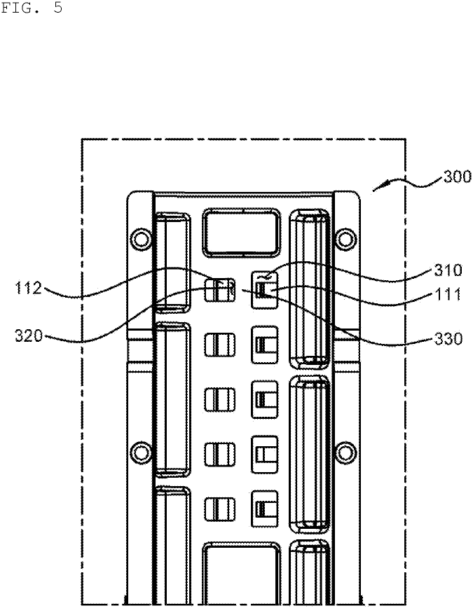

As shown in FIG. 5, in the optical mechanism part 300, a through-hole 310 for a light source may be formed on an upper side corresponding to the light source 111, and a through-hole 320 for an optical sensor may be formed on an upper side corresponding to the photosensor 112. In addition, the optical mechanism part partition 330 may be formed between each of the through-hole 310 for a light source and the through-hole 320 for a photosensor.

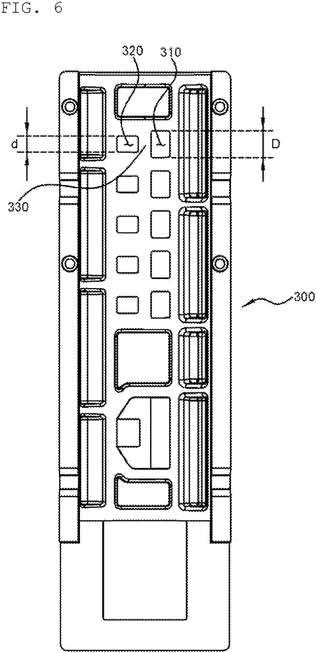

At this time, as shown in FIG. 6, a width D of the through-hole 310 for a light source is preferably equal to or longer than a width d of the through-hole 320 for a photosensor. Alternatively, the through-hole 310 for a light source may be formed to be larger than the through-hole 320 for a photosensor. This is to improve the sensitivity of the device 1000 for detecting an analyte in a sample by focusing light toward the photosensor 112.

In addition, an area in which the through-hole 310 for a light source and the through-hole 320 for a photosensor are formed may be formed to include a wider area than the stick housing through-hole 210 formed in the stick housing 200, and the stick housing through-hole 210 of the stick housing 200 may include both areas in which the through-hole 310 for a light source and the through-hole 320 for a photosensor are formed. This is to prevent light from being reflected or scattered by the stick housing 200 formed of a bright color that reflects light.

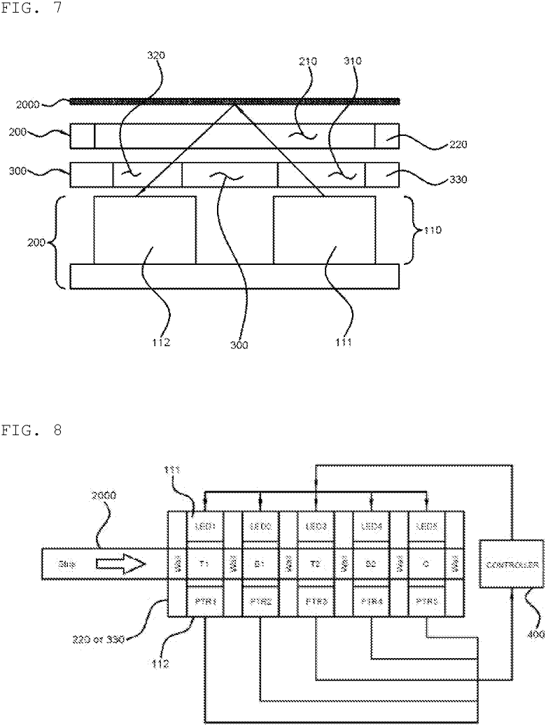

FIG. 7 shows an operation of the measurement area when both the stick housing 200 and the optical mechanism part 300 are included. In the optical mechanism part 300 a through-hole 310 for a light source and a through-hole 320 for a photosensor are separately formed so that the optical mechanism part partition 330 may be located between the light source 111 and the photosensor 112. Accordingly, it is possible to prevent light generated from the light source 111 from being directly received by the photosensor 112 without reacting in the measurement target 2000, and a path of light may be secured as the light source 111 - the through-hole 310 for a light source - stick housing through-hole 210 - the measurement target 2000 - the through-hole 320 for a photosensor - the photosensor 112. Accordingly, the straightness of light may be increased and the accuracy of the measurement may be further improved.

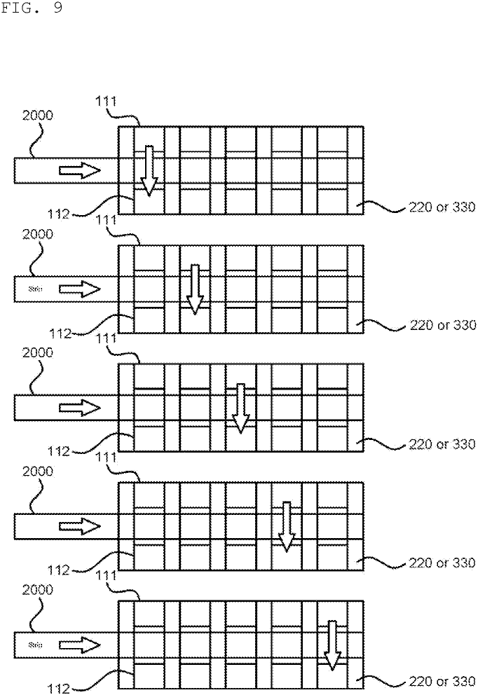

Hereinafter, a controller 400 connected to the device 1000 for detecting an analyte in a sample according to the present invention and a control method will be described with reference to FIGS. 8 to 10.

As shown in FIG. 8, the device 1000 for detecting an analyte in a sample may include the controller 400 connected to the measurement unit 110. The controller 400 may control the light source 111 to generate light, receive light information received from the photosensor 112, and transmit measured information to the outside. Hereinafter, a control method for more accurate driving of the device 1000 for detecting an analyte in a sample of the present invention will be described, and beforehand, when the measurement units 110 are first to n-th measurement units 110 arranged in order in one direction, the light source 111 included in the n-th measurement unit 110 is referred to as an n-th light source 111, and the photosensor 112 included in the n-th measurement unit 110 is referred to as an n-th photosensor 112.

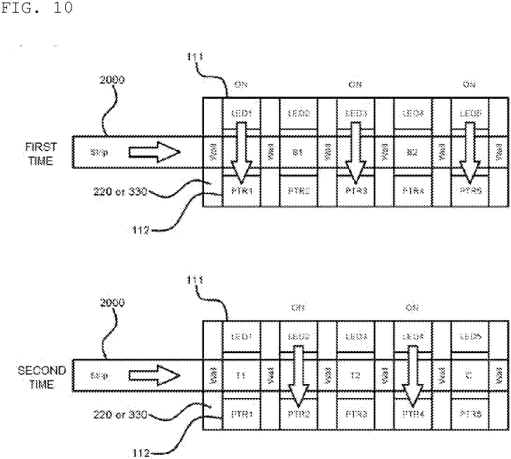

In the first exemplary embodiment of the control method shown in FIG. 9, the first light source 111 to the n-th light source 111 may be sequentially operated one by one. Thereafter, the result values of the first to the first photosensors 112 respectively corresponding to the light sources 111 may be received. At this time, each light source 111 is preferably turned on at a different time. That is, a process in which light information of the first optical sensor 112 is received, while the first light source 111 is turned on, the first light source 111 is turned off, and thereafter, the second light source 111 is turned on may be performed up to the n-th light source 111 and the n-th photosensor 112. Alternatively, in the case of using a time-division fluorescence measurement method, a process in which light information is received from the first photosensor 112 after the first light source 111 is turned on and off instantaneously, and thereafter, the second light source 111 is turned on and turned off may be performed up to the n-th light source 111 and the n-th photosensor 112. Accordingly, when sensing one measurement area, it is possible to minimize the interference of the measurement unit 110 other than the measurement unit 110 corresponding to the measurement area.

This is a control method that has been carried out in the existing device for detecting an analyte in a sample, and this method may be slightly inefficient in the present invention in which the stick housing partition 220 is formed to block most interference.

In a second exemplary embodiment of the control method shown in FIG. 10 presented here, the measurement units 110 are divided into two or more groups, and one or more measurement units 110 are included in one measurement unit 110 group to simultaneously operate the light sources 111 included in the measurement unit 110 belonging to one group and to receive result values from the photosensors 112 corresponding to the respective light sources 111. At this time, it is preferable that each measurement unit 110 group operates at a different time.

For example, when it is assumed that first, third, and fifth measurement units 110 form a measurement unit 110 group 1, and second and fourth measurement units 110 form a measurement unit 110 group 2, first, after turning on all the first, third, and fifth light sources 111 included in the measurement unit 110 group 1 at the same time, light information of the first, third, and fifth photosensors 112 corresponding to each light source 111 is received and, when the measurement is completed, the second and fourth light sources 111 included in the measurement unit 110 group 2 are turned on at the same time, and then light information of the second and fourth photosensors 112 corresponding to each light source 111 is received.

In the second exemplary embodiment, a plurality of measurement units 110 are simultaneously driven, which may be performed because the stick housing partition 220 or the optical mechanism part partition 330 is formed between the measurement units 110 to minimize mutual interference.

However, the following restrictions may be made in order to further increase the accuracy of measurement. In order to minimize mutual interference, it is preferable that one measurement unit 110 group does not include the measurement units 110 adjacent to each other. For example, it is preferable that the second and third measurement units 110 are not included in the measurement unit 110 group 3. In addition, it is preferable that one measurement unit 110 is not included in a plurality of measurement unit 110 groups, and is included only in one measurement unit 110 group.

In addition, a third exemplary embodiment of the control method is to receive light information of the first to n-th photosensors 112 after turning on all of the first to n-th light sources 111 at the same time. In the device 1000 for detecting an analyte in a sample of the present invention, since the stick housing partition 220 is formed between each measurement area, mutual interference is less than that of the related art device for detecting an analyte in a sample, so that the accuracy is high even when the present control method is performed. Accordingly, time may be shortened and the efficiency is maximized.

A fourth exemplary embodiment of the control method is a method of removing noise. When j, which is a natural number and 1≤j≤n, is designated, a (j-1)-th light source 111 and a (j+1)-th light source 111 are turned on to measure a value of the j-th photosensor 112 to calculate a noise value. That is, the effect of the light source 111 included in the measurement unit 110 adjacent to each measurement unit 110 on the photosensor 112 is recognized in advance. This may improve accuracy by removing noise expected when the method of simultaneously turning on and off the light sources 111 in adjacent measurement areas as suggested in the second or third exemplary embodiment of the control method later is adopted.

As described above, in the present invention, specific matters such as specific components and the like and limited exemplary embodiment drawings have been described, but these are only provided to help a more general understanding of the present invention, and the present invention is limited to one exemplary embodiment above. It is not, and a person of ordinary skill in the art to which the present invention pertains may make various modifications and variations from these descriptions.

Therefore, the spirit of the present invention should not be limited to the described exemplary embodiments, and not only the claims to be described later, but also all those with equivalent or equivalent modifications to the claims will be said to belong to the scope of the spirit of the present invention.

1. A device for detecting an analyte in a sample, the device comprising:
a substrate including n measurement units; and
a stick housing accommodating a measurement target including n measurement areas spaced apart from each other, and stacked on the substrate,
wherein the stick housing includes n stick housing through-holes formed on an upper side corresponding to the n measurement units in a direction facing the substrate and a stick housing partition formed between the respective stick housing through-holes, wherein the stick housing through-holes are formed at a position corresponding to the measurement units, and n is a natural number greater than 2.

2. The device of claim 1, wherein
each of the measurement units includes at least one light source irradiating light to the measurement target and at least one photosensor receiving and sensing light reflected from the measurement target, and
the measurement units are spaced apart from each other.

3. The device of claim 2, further comprising:
an optical mechanism part stacked on the substrate and the stick housing,
wherein the optical mechanism part includes a through-hole for light source on an upper side corresponding to the light source and a through-hole for a photosensor on an upper side corresponding to the photosensor.

4. The device of claim 3, wherein
the optical mechanism part is provided between the stick housing and the substrate.

5. The device of claim 2, further comprising:
a controller connected to the measurement unit,
wherein when the measurement units are respectively first to n-th measurement units arranged in order in one direction, the light source included in the n-th measurement unit is an n-th light source, and the photosensor included in the n-th measurement unit is an n-th photosensor, the controller sequentially operates the first to n-th light sources one by one, receives only an output from a j-th photosensor corresponding to a j-th light source, among the first to n-th optical sensors, operated at an operating time of each light source, and 1≤j≤n.

6. The device of claim 2, further comprising:
a controller connected to the measurement unit,
wherein when the measurement units are respectively first to n-th measurement units arranged in order in one direction, the light source included in the n-th measurement unit is an n-th light source, and the photosensor included in the n-th measurement unit is an n-th photosensor, the controller divides the first to n-th measurement units into a plurality of groups, simultaneously operates light sources included in a plurality of measurement units belonging to one group, receives result values from photosensors corresponding to the simultaneously operated light sources, and each group operates at a different time.

7. The device of claim 6, wherein
the measurement units included in one group of the measurement units are located in positions that are not adjacent to each other.

8. The device of claim 2, further comprising:
a controller connected to the measurement unit,
wherein when the measurement units are respectively first to n-th measurement units arranged in order in one direction, the light source included in the n-th measurement unit is an n-th light source, and the photosensor included in the n-th measurement unit is an n-th photosensor, the controller turns on a (j-1)-th light source and a (j+1)-th light source, measures a value of the j-th photosensor to calculate a noise value, and 1≤j≤n in which j is a natural number.
